(19) United States
(12) Patent Application Publication
(10) Pub. No.: US 2003/0062847 A1
(43) Pub. Date: Apr. 3, 2003

(54) Fluorescent luminaire capable of starting with broken filament

(76) Inventor: Ye Guan Rong, Hangzhou (CN)

Correspondence Address: A. Blair Hughes, McDonnell Boehnen Hulbert & Berghoff, 32nd Floor, 300 S. Wacker Drive, Chicago, IL, 60606, US

(21) Appl. No.: 10/078,148

(22) Filed: Feb. 19, 2002

(30) Foreign Application Priority Data
Sep. 29, 2001 (CN) 01 1 35450.X
Dec. 26, 2001 (CN) 01 1 36963.9

(51) Int. Cl. H05B 37/02

(52) U.S. Cl. 315/219; 315/224

(57) ABSTRACT

A kind of energy-saving fluorescent luminaire complying to Energy Star criteria, consisting of electronic ballast and pre-heat form fluo bulb. Each filament is parallel connected with a voltage-stabilizer, and said ballast has a high position trigger circuitry for increasing the peak voltage of oscillation output. When the filament is un-broken, said ballast started the bulb per traditional pre-heating form through the thermal resistor. When the filament is broken, since the starting capacitor can still be charged, the bulb can be started by higher voltage of the cold cathode form. And the resonant circuitry formed by choke and the starting capacitor raises said peak voltage 2 or 3 times thus to excite and start the bulb. Therefore, no matter the filament is broken or not, the coating on the filament can be completely used out. This in return will elongate the lamp-life to 2 or 3 times as ever.

### FIELD OF THE INVENTION

This invention relates generally to a kind of energy saving fluorescent luminaire, especially to the luminaire being capable of starting when its lamp filament is broken and complying to the criteria of “Energy Star”(ES) of USA, especially to the new lamp-life requirement, while the purchasing cost is similar to Incandescent one, for example, Halogen torchiere.

### BACKGROUND OF THE INVENTION

Nowadays countries of the world are promoting Safety and Energy-Saving. Since traditional 300 W Halogen torchieres frequently cause fire incidents and have a low lumen/watt ratio (20 lm/W), US government has limited its use again and again and this caused its sales volume down very rapidly. Many famous manufacturers put in the market their newly designed 55 W fluorescent torchieres for replacing the traditional 300 W Halogen torchieres. Since the cost of a Halogen bulb is less than 40 cents while a 55 W fluorescent bulb plus its electronic ballast will cost 4 dollars, and, incandescent torchiere being replaced by fluorescent torchiere must face rigid limitation of Electromagnetic Interference (EMI) (see FCC regulations, Part 18). The production cost will be doubled. For example, the 2D-55 W GE fluorescent torchiere has the price 4 times of GE Halogen torchiere.

The “Energy Star” project is rebated by the US government (EPA). It is required that any ES luminaire must comply with the following requirements: energy saving, electrical safety, EMI, low noise, CRI (color rendering index), quick start at low temperature, two-year warranty (at least the purchased luminaire shall be continuously operated in 17,520 hours), etc. It is not difficult to design a luminaire for complying to said requirements but the cost will be raised to an un-competitive degree even if EPA rebated it. For example, the fluorescent bulb and the electronic ballast of ES torchiere of GE has a cost more than 20 dollars while an incandescent torchiere only costs 10 dollars. The rebate will be no more than 10 dollars. Thus, there are much price difference between incandescent torchiere and fluorescent torchiere. Nobody will pay 4 dollars for a thing only valued 1 dollar. Only one way for competition, that is to design an ES luminaire with its price similar to incandescent ones.

Besides, as one of the prior art of this invention, the GE 2D-55 W fluo torchiere is separately designed and manufactured/assembled. That is, fluo bulb is designed and manufactured in USA while electronic ballast is designed and manufactured in Italy. And the luminaire assembly is carried out in China. Therefore, when designed the ballast, nobody knows what is the real condition of capacitance and antenna effect in whole lamp. Thus, even though the ballast used complicated active anti-EMI circuitry and passed FCC testing, the whole luminaire after assembly still failed to meet FCC requirements because of the antenna effect caused by additional 4-meters-long power cord and capacitance effects caused by metal lamp shade, metal lamp stem, etc., which must be added to the ballast. To solve this problem, the same inventor of present invention had filed a Chinese Patent CN 01207763.1, in which, with simple electronic circuitry and considering the EMI distribution in whole luminaire, provided an ES luminaire which complied to ES criteria of that time.

U.S. Pat. No. 6,111,369 describes a kind of electronic ballast connecting two filaments terminals together of each bulb. In doing so, when a lamp filament is broken, the lamp may still start-up. However, this function is not intentional. Said connecting is caused by secondary winding of a transformer used to supply filament current. The circuit is still operating in traditional way, i.e., preheat the filaments to start the bulb.

In said prior arts there is a common shortcoming, i.e., all designs are based on an old view of point, without fully understanding the function of both fluo bulb and electronic ballast. For example, the ballast is only designed for the function of traditional magnetic ballast for pre-heating fluo bulb. Since the filament of said fluo bulb in operation only has one point heated and in red color and said heated portion has a temperature of about 1,200 K, once the coating for electron emission is evaporated, the filament will be broken at this portion. If a broken takes place in any of the two filaments, the pre-heat circuitry will open and no pre-heating will take place hereafter, that is, no starting will be done anymore. The fluo bulb is deemed to the end of its lamp-life. To defer the filament being broken, until now, only using double coiled filament or triple coiled filament for bigger section area of the filament wire and bigger containing space of the coating will be achieved. But this is a passive solution since once the filament is broken, the fluo bulb still can not start.

From Jul. 1, 2001, ES criteria is changed and lamp-life requirement is added into it. All kinds of bulb must have a minimum lamp-life of 10,000 hours. The testing procedure of lamp-life nowadays is to lit the bulb with a cycle of 3 hours and 45 minutes ON and 15 minutes OFF. Once the filament is broken in ON period, it can still work. But when this bulb is OFF, it can never start again and its life is over. Therefore, the life span of common fluo bulb is only around 8,000 hours. Thus, using prior art Ballast-bulb Combination (in the following, “Combination” for short), the newly added lamp-life test will be hard to pass.

### SUMMARY OF THE INVENTION

An object of present invention is to provide a kind of fluo luminaire, which can restart after the filament is broken. So the fluo luminaire of present invention complies with the newly revised ES criteria, especially complies with its lamp-life requirement while the cost of this invented luminaire is still at the same level of present Halogen one when the rebate is subtracted. Therefore, it will be very competitive in US market.

Another object of present invention is to provide a method to restart the fluo luminaire after its filament is broken. It is achieved by automatically connecting filament terminals with zener diode and using higher voltage on the fluo bulb.

It is a further object of some aspects of the present invention to provide improved devices and methods for filaments being driven at constant voltage to elongate the life span of the fluorescent luminaire.

For achieving the object of both low cost and accordance with relative criteria, this invention adopts the design method to analyze the life of every parts of the whole Combination and make all parts of said Combination to operate to the end of its life. Therefore, the Combination will operate in its whole life with 3 different periods. To do so, the 8,000 hours lamp-life in prior arts can be elongated to more than 20,000 hours.

According to the technical solution of present invention, the advantage is obviously comparing to the circuit of ballast in prior art. It proximately elongates the life of the normally used fluo bulb of prior art to 3 times while the cost of fluo luminaries of present invention does not increase.

### BRIEF DESCRIPTION OF THE DRAWINGS

In the following text through the description of specified embodiments with reference to the drawings the technical solution of present invention and its other advantages will be obvious.

FIG. 1 is a drawing for operation principle of prior art fluo bulb;

FIG.2 is a sketch of the bulb with broken filaments shown in FIG. 1;

FIG.3 is a drawing for operation principle of fluo bulb of this invention, showing two zener diodes connecting each two filament-terminals. A thermal resistor and an oscillation capacitor parallel connected with fluo bulb;

FIG.4A is a circuit diagram of one specified embodiment of present invention, of which the ballast starts fluo luminaire by traditional trigger circuit;

FIG.4B is a circuit diagram of another specified embodiment of present invention, of which the ballast starts fluo luminaire by high position trigger circuit;

FIG.5 is a state diagram for showing the filament of common pre-heat fluo bulb;

FIG.6 is a circuit diagram of the third operation period of present invention;

FIG.7 is a circuit diagram of another embodiment of this invention, showing that two zener diodes are inversely connected in series and then parallel connected to filaments at each side of fluo bulb;

FIG.8 is a sketch of another embodiment of present invention, showing filament terminals shortly connected in circuit by connecting wires;

FIG.9 is a circuit diagram of another embodiment of present invention, in which a igniting capacitor is parallel connected with fluo bulb on the supplying side of the fluo bulb while a thermal resistor is parallel connected on the other side.

FIG. 10 is a circuit diagram of another embodiment of present invention, in which two zener diodes are inversely connected in series and then parallel connected to the filament.

### DETAILED DESCRIPTION OF THE PREFERRED EMBODIMENT

In one preferred embodiment of this invention, when the fluo bulb is new, the Combination will start in traditional pre-heat form with two filaments under constant voltage. When the first broken of filament takes place, the Combination will automatically connect the terminals of broken filament outside the bulb and make the prior art starting capacitor charged to a higher voltage for start in hot cathode form. When the second filament is broken, the second start period ended, all filament-terminals will automatically connect by zener diodes and the starting capacitor will be charged to a highest voltage for third cold cathode start period.

Since different kinds of luminaire have different difficulties in complying with ES criteria, the easiest kind is fixing luminaries with small wattage (under 20 W). The first reason is that the EMI level is proportional to wattage. The smaller the wattage is, the smaller the EMI emission. Secondly, fixing luminaire has no long power cord, just as a transmitter without antenna; the emission function will be greatly reduced. Thirdly, ES criteria classify luminaries by wattage into 3 categories, i.e., 1-19 W, 20-29 W and 30-150 W. The category with smaller wattage has milder requirements for the purpose to push everybody saving energy. Therefore, present invention uses the most difficult kind, 55 W portable luminaries, for its embodiment. Anyone understanding this embodiment will easily master the whole range from 9 W to 60 W, fixture to portable.

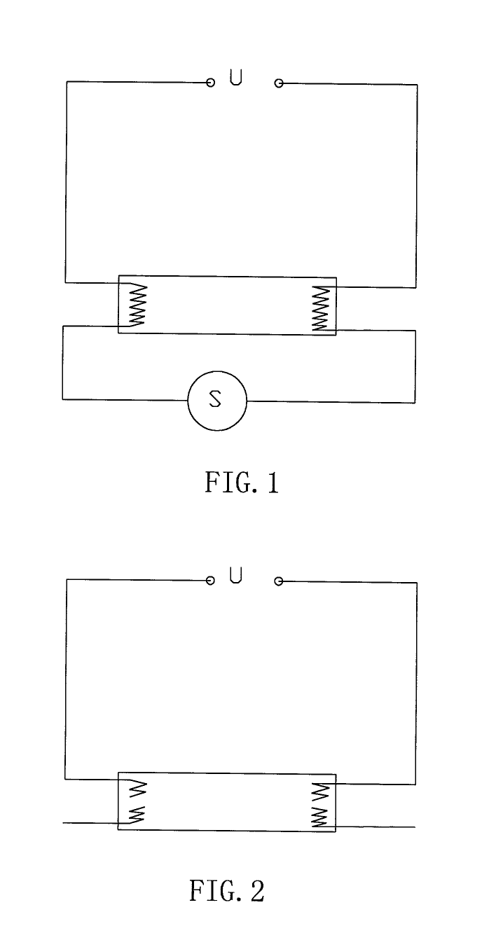

In FIG. 1, there shows a pair of filaments of traditional hot cathode fluo bulb that must be pre-heated electrically to raise the filament temperature to such a level that electron can emit under the voltage and frequency supplied for starting. Due to hot cathode fluo bulb is now widely used and produced, the inventor decides to use it in this invention. But this is not the limitation of usage of this invention. In the first operation period of this invention (approximately 8,000 hours) the operation form is still the traditional low voltage, high temperature starting and low voltage, low temperature lighting form of hot cathode, pre-heat fluo bulb.

In this circuitry, since two filaments have different resistance, the supply voltage U is unstable, and the starter S has very rough time-control, therefore, the pre-heating is uneven and always one filament will be over-heating and caused its broken.

In FIG. 2, the difference is the break of the filament. We suppose one-third of the filament has been evaporated and broken (In fact, the broken portion will be less than one-third of the whole length of a filament and the position is always near the terminal). Any one can see that the remained two-third of filament is still useful and will continue to work if the lamp is ON. But since all filaments can not be pre-heated, we can only use cold cathode starting form, i.e., high voltage starting form, and said filament broken fluo bulb can still operate. After starting, the fluo bulb must operate in its hot cathode form. Thus, once started, the operating form must be changed to its low voltage, low temperature working situation. This is the operating principle of cold cathode starting form and hot cathode working form required by second and third operation period of this invention.

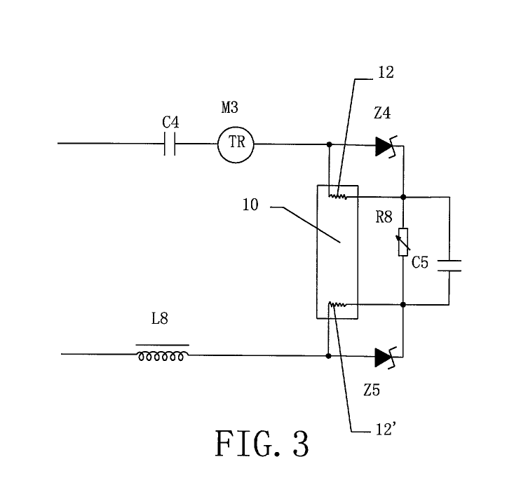

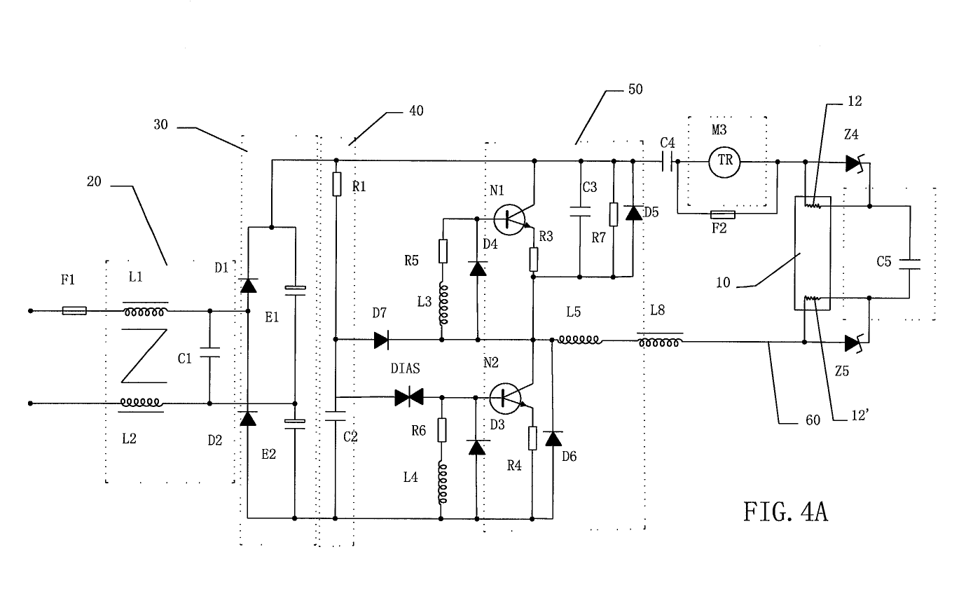

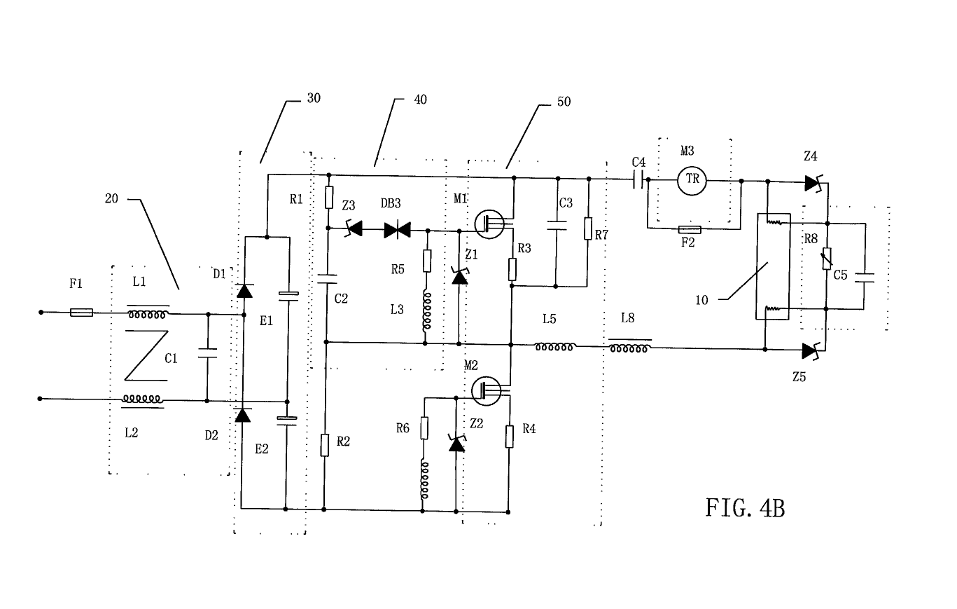

As shown in the circuit diagram of FIG.3, a thermal resistor R8 and an oscillation capacitor C5 are respectively parallel connected between the two ends of the bulb 10. And between terminals of each of the filaments 12 and 12′ are two zener diodes Z4 and Z5 connected in parallel. In doing so, each filament only to be pre-heated in half-cycle, and under constant voltage. The uneven pre-heating and over-heating will never take place. According to the technical solution of present invention, a specified embodiment of ballast of present invention, i.e., a preferred circuit diagram, is shown in FIG.4A. The control circuit of present invention is directly achieved by improving the ballast circuit in prior art. Said ballast circuit in prior art (CN 01207763.1) comprises:

a filter circuit 20 connecting to power source;

a doubler and rectification circuit 30;

an integrator 40 connecting to said doubler and rectification circuit 30, which comprises a resistor component R1 and a capacitor component C2 connecting in series;

an oscillation switch circuit 50 comprising two transistors N1 and N2 in series connection wherein control electrode of the transistor N2 is parallel connected to the capacitor component of the integrator 40;

a low position trigger circuit made up of a capacitor C4 being series connected on the supplying side of the bulb 10; and

an oscillating circuit 60 in which the inductor component L8 is series connected to the bulb 10 while the capacitor component C5 is connected in parallel with the bulb 10 as its starting component.

In present invention, there are at least two voltage-stabilizers Z4 and Z5 each parallel connected with filaments 12 and 12′ respectively. Therefore, when the filament 12 or 12′ is blown out, the terminals of the filament are still connected due to bi-directional connection function of the voltage-stabilizers. The starting current can still make the starting capacitor C5 charged until the bulb is activated by hot/cold cathode form though it can not pre-heat the broken filaments 12 and/or 12′. As by cold cathode form the bulb needs higher voltage to start, the solutions in present specified embodiment (see FIG. 4B) are as follows: (1) The trigger portion of this invention has been changed to use high position trigger circuit. Thus, the peak value of oscillation output will be twice the voltage of one MOSFET, around 300 V (DC) in this embodiment, while in prior art it is only 150 V (DC). (2) Use thermal resistor R8 to replace prior art starting capacitor (15 n/1000V), because in frequent starting condition, capacitor is sensitive to peak voltage and easy to be broken down by it while resistor will only response to average value of current intensity. Besides, the starting capacitor to be placed per FIG.4A will not act in cold cathode form without Z4 and Z5 when filament is broken.

Now the first embodiment of this invention will be described in detail per FIG. 4B. (1) First operation period. When the fluo bulb 10 is new, because the filaments 12 and 12′ are not broken, the starting current goes through said filaments and pre-heat them as well as charge the starting capacitor C5. Under room temperature the bulb will act below 300V successfully. The output 50 KHz square-wave current from the oscillating circuit overshoot capacitor C4 and inductor L8 and enter the supplying side of both filaments 12 and 12′, that is, the right side of thermal protecting component TR and the bottom side of oscillating capacitor C5. Since at this time the thermal resistor R8 is cold and the resistance is very low, current can easily flow through both the filament 12, 12′ and the thermal resistor R8 and heat them up. The resistance of the thermal resistor R8 can be raised when heated up and stop the current continuously to flow through. Thus, the high frequency voltage on capacitor C5 will be raised. Since the filaments had been heated, the voltage on capacitor C5 not higher than 250V will easily excite the fluo bulb and makes it started. Therefore, in this first operation period, capacitor C5 plays no new role. The operation principle of this period is the same as that in prior art. Here gives no superfluous details.

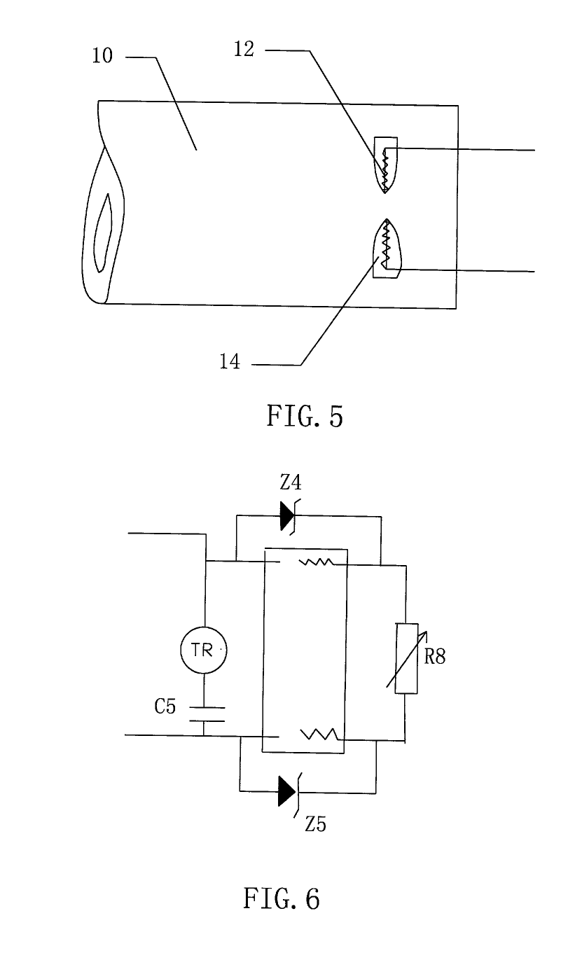

(2) Second operation period. When one of the filaments 12 or 12′ in present invention is broken, said first operation period finished. Usually said first period will consume 7,000 to 8,000 hours. In FIG. 5, there shows the vaporized coating 14 for electron emission and broken filament 12. Since in this time, only less than one-third of the total length of the filament is useless, the remained each one-third length on the left and right side of said useless portion is still useful. What should be made clear is that, although in this specification it is assumed that the break takes place at the center of the filament, in fact it can happen on any part at length of the filament and one-third break at center is only for the convenience to specify. But in all prior arts the bulbs with broken filament couldn't be used due to the failure of pre-heating. While in this invention a pair of voltage-stabilizers (zener diodes) Z4 and Z5 are added, the pre-heating current can still flow through the filament not broken and pre-heat it as well as charge the starting capacitor, though it can not pass through the broken filament. The fluo lamp is now preheated by one filament and then applying hot cathode starting form. This is the beginning of the second operation period. Under room temperature the voltage in starting capacitor C5 needs to be charged more than 300V to successfully start the fluo lamp.

(3) Third operation period. When the second filament is also broken, since now the pre-heat by-pass circuitry does not exist, the LC resonant circuitry formed by the capacitor C5 and the inductor component L8 begins to resonate with oscillation output current. After some time period, the high frequency voltage on the capacitor C5 exaggerated quickly. Once the voltage reaches 600 V more or less, the fluo bulb will be excited and started. Per ES criteria, the starting period must be less than 1 second. So usually it is designed at 0.8 second. Once started, because the current smoothly bypasses from filament to filament, the capacitor C5 returns to stop condition. This is the third operating period.

Since there is no preheating at all, the start fully depends on cold cathode starting form, i.e., low temperature and high voltage. As shown in FIG.6, the third operation period begins now. At this period it needs about 600V to start under room temperature. In this case, the thermal resistor R8 will be pre-heated to have a very big resistance so it can be deemed not existing.

When any one of the filaments exhausted, the third operation period finished. Since the fluo bulb has no useful filament can be utilized, the fluo bulb is deemed to the end of its lamp-life. In this time, the capacitor C5 plays the only role as the “load” of oscillation output. The current continuously passing through capacitor C5 will cause the thermal protecting component TR in series hotter. High temperature on TR will cause it function to cut the circuitry. Therefore, the oscillation portion will stop working and high frequency square-wave current output will also be stopped.

To balance the cost, the above-mentioned thermal protecting component TR (in both FIG. 4A and 4B) can be substituted to common fuse F2. In the first specified embodiment of present invention, the doubler and rectification circuit 30 is adopted to raise the voltage added to the bulb. Of course any other rectification component, such as iron-core rectifier, can be used to raise the output voltage. And as shown in FIG.4B, the switch component in the oscillating switch circuit of this invention, which is shown in FIG.4A, can be substituted by MOSFET.

In fact, the fluo luminaire in present invention may set the voltage-stabilizing components Z4 and Z5 directly in its ballast. And also, they may be set in the two ends of the bulb 10 in products.

As this embodiment is economically designed to replace the 2D-55 W GE Halogen torchiere, the details of every component is disclosed. The value of the voltage-stabilizers Z4 and Z5 are determined by the voltage and current of the filament, for example, for 24 W fluo bulb 6V/0.5 W's is used. Since one of embodiments of present invention only adds two voltage-stabilizers to the Combination of prior art, all ballasts can conveniently use two voltage-stabilizers to become this invention. For example, after using the two voltage-stabilizers, the HF-P128 TL5 220-240 produced by Phillips Co. can keep the 28 W T5 fluo bulb with broken filament on working.

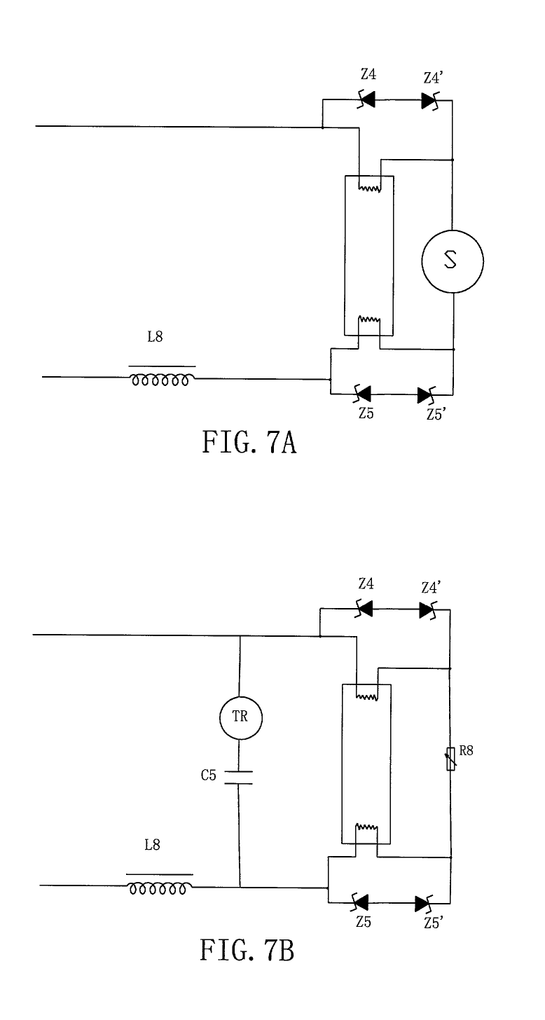

As shown in FIG.7 is a circuit diagram of the fluorescent luminaire of another embodiment of this invention. When the 48 inch spec fluo bulbs with traditional magnetic ballast (i.e. common family using ones) are adopted, what's much better is that, at each end of the bulb 10, shall parallel connect two voltage-stabilizers inversely connected in series. Such as voltage-stabilizers Z4 and Z4′, Z5 and Z5′, which are 7V/1 W spec. In doing so, when one filament is broken, the combination can still work. But when both filaments are broken, the combination will not work since the starting voltage in this case is less than 400V. In this case, the filament can be pre-heated in full cycle. This is very useful to any fluo luminaire must be started in cold environment. Of course, since now 4 zener diodes are used, the cost will be a little higher than embodiments with 2 zener diodes.

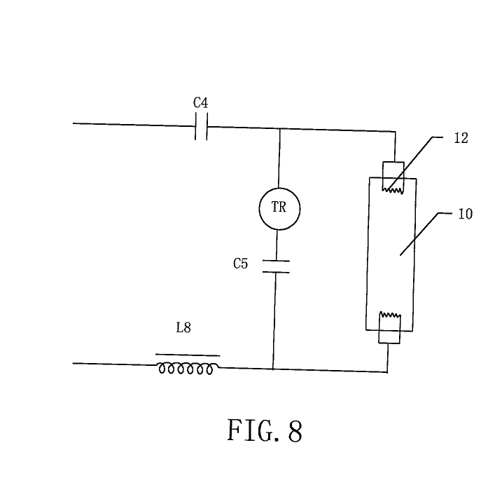

What's shown in FIG. 8 is a circuit diagram of the fluorescent luminaire of another embodiment of this invention, in which the starting capacitor in prior art is changed to the supplying side of the bulb 10 in parallel. Therefore, the capacitor C5 and the choke L8 form an LC resonant circuitry. When the resonant frequency of said LC resonant circuitry is set close to the output frequency of the oscillation portion, the output voltage will be raised to 2 to 3 times in a time period. That is to say, from 300 V to 800 V. Since ES criteria request the working frequency of the ballast must be no less than 40 KHz, the fluo bulb will be easily started in this condition. Since the difference between the embodiments is only around the fluo bulb, only different portion is shown. In the embodiment shown in FIG. 8, the pre-heat function, i.e., the resistor R8 is deleted, and two terminals of each filament are connected together. The luminaire can be started only by cold cathode form. The advantage of this embodiment is obvious for those luminaires should be operated 24 hours a day. Firstly, a thermal resistor R8 can be saved. Secondly, the fluo bulb and electronic ballast life ration can be changed from 1:5 to 1:1. The fluo bulb and the electronic ballast will end in same time, no bulb replacement is in need. This is especially good for integral CFLs.

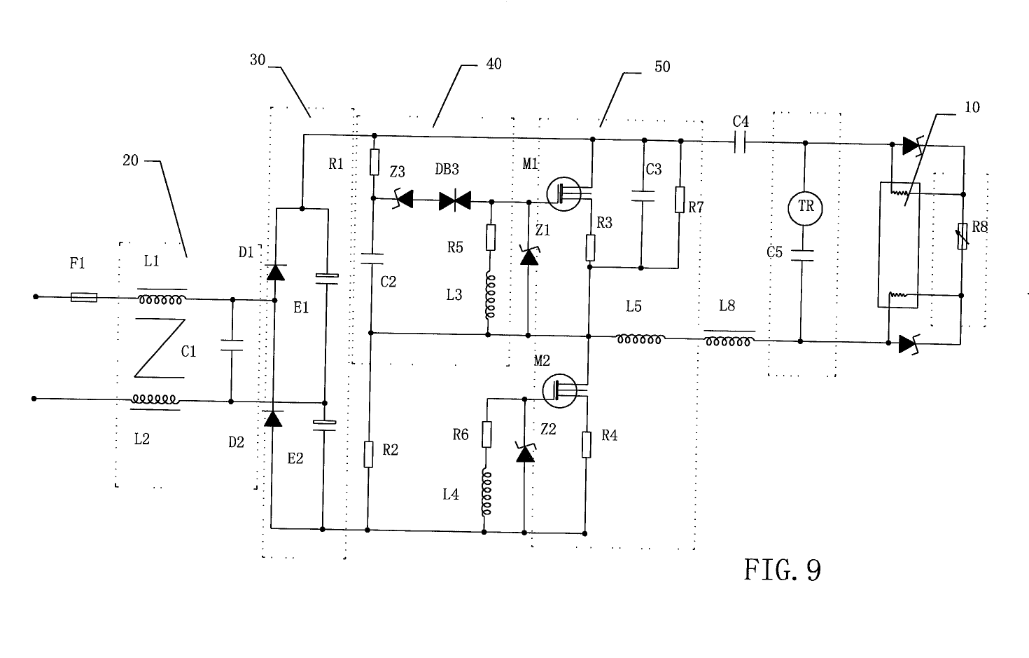

However, while a thermal resistor R8 is parallel connected to the output side of the fluo bulb, the fluo bulb 10 will be also started by pre-heating form in the first operation period, as shown in FIG.9. After the filament 12, 12′ are broken, it shall be started automatically by high voltage of the cold cathode form.

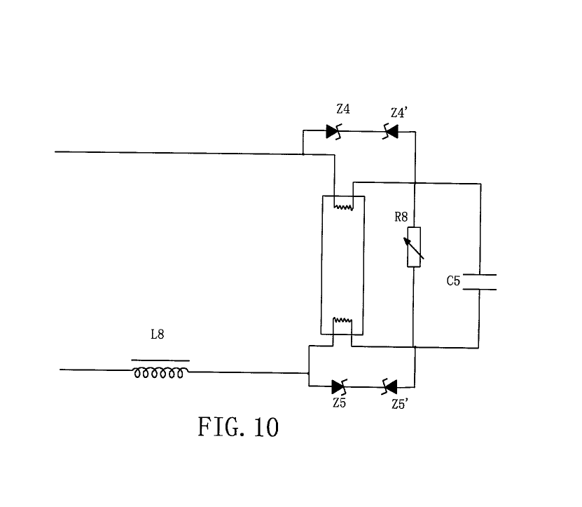

FIG. 10 is another embodiment of this invention. In which, two zener diodes are inversely face to face in series connected and then parallel connected to the filament. In doing so, the filament can be pre-heated in full cycle. This is very useful to any fluo luminaire must be started in cold environment. Of course, since now 4 zener diodes are used, the cost will be a little higher than embodiments with 2 zener diodes.

What is claimed is:

1. A fluorescent luminaire, consisting of
A fluo bulb for lighting;
A traditional electronic ballast and starting light circuitry, connecting to the power source;
wherein, the fluorescent luminaire also comprises
At least two voltage-stabilizing components respectively parallel connected with each filament.

2. A fluorescent luminaire, consisting of
A fluo bulb for lighting;
A rectifying circuitry, connecting to the power source;
A integrating circuitry, comprising at least a resistor and a capacitor in series connection while parallel connected with the rectifying circuitry;
An oscillating switch circuitry, comprising
Two transistors in series connection, in which one transistor is triggered by the capacitor of the integrating circuitry; and
Mutual induction coils, respectively consisting of two inversely connected with the control electrode of the two transistors and one connected in the main operating circuit of the fluo bulb for controlling the two transistors alternately activate;
A high position trigger circuitry, comprising a capacitor component connected in the main operating circuit of the fluo bulb;
An oscillating circuitry, comprising
An inductive component connected in the main operating circuit of the fluo bulb;
A starting capacitor component, parallel connected with the fluo bulb,
wherein, the fluorescent luminaire also comprises
At least a pair of voltage-stabilizing component, respectively parallel connected with each filament.

3. A fluorescent luminaire according to claim 2, wherein, the fluorescent luminaire also consists of a thermal resistor, parallel connected on the output side of the fluo bulb.

4. A fluorescent luminaire according to claim 3, wherein, in series connection with the starting capacitor component is a thermal protecting instrument which can stop the circuit while the coating on filament can not emit electrons due to evaporation.

5. A fluorescent luminaire according to claim 4, wherein, the thermal protecting instrument is a fuse.

6. A fluorescent luminaire according to claim 1, wherein, the fluorescent luminaire has two pairs of voltage-stabilizing components, of which each pair are connected inversely in series then respectively parallel connected to one filament.

7. A fluo bulb, consisting of
A bulb body;
A bulb cap; and
A pair of filaments setting in the bulb body, connected in an electricity supplying circuit,
wherein, the fluo bulb has
At least a pair of voltage-stabilizers, respectively parallel connected with each filament.

8. A fluo bulb according to claim 8, wherein, at each pair of terminals of the fluo bulb set two voltage-stabilizing components inversely connected in series then parallel connected to said pair of terminals.

9. A method to start the fluorescent luminaire, comprising
At the outside of each filament is at least one voltage-stabilizing component parallel connected, for the time any filament is broken, to connect the power supplying circuit and start the fluo bulb with high voltage by using the peak voltage superposed on the bulb.

10. A method to start the fluorescent luminaire, comprising
In ballast set a high position trigger circuitry, by which the peak voltage on the pair of filaments from the oscillation output is the sum voltage of the two triodes;
Parallel connect the capacitor of the resonant circuitry in the ballast with the pair of filaments at their load side, to pre-heat and start the fluo bulb with cold cathode form;
Parallel connect at least one voltage-stabilizing component with each filament at its outside, so that when any filament is broken it will connect the operating circuit and activate the fluo bulb with high voltage by using the peak voltage superposed on the bulb.

11. A method according to claim 10, wherein comprising: parallel connect a thermal resistor with the fluo bulb at its load side to pre-heat and start the fluo bulb.

12. A method according to claim 10, wherein comprising: in the resonant circuitry is a thermal protecting instrument connected, by which when the coating on filament is evaporated and can not emit electron any more, the whole circuit is cut off due to the capacitor becomes the load of the oscillation output and the temperature of the thermal protecting instrument is raised by the increased current passing by.

13. A method according to claim 11, wherein comprising: set the resonant frequency of the LC resonant circuitry formed by the starting capacitor and the choke in ballast similar to the frequency of the oscillation output current, so that the starting capacitor can be resonantly charged in a fixed time to the voltage to excite and start the fluo bulb.

14. A fluorescent luminaire, comprising
A fluo bulb for lighting;
A rectifying circuitry connected to power source;
A integrating circuitry, formed by at least a resistor component and capacitor component in series connection while parallel connected with the rectifying circuitry;
A oscillating switch circuitry, consisting of
Two transistors in series connection with each other, in which one is triggered by the capacitor component of the integrating circuitry; and
Mutual induction coils, respectively consisting of two mutual induction coils inversely connected with the control electrode of the two transistors and one connected in the main operating circuit of the fluo bulb, for controlling the two transistors alternately activate;
A high position trigger circuitry, comprising a capacitor component connected in the main operating circuit of the fluo bulb;
An oscillating circuitry, comprising
A inductive component, connected in the main operating circuit of the fluo bulb;
A starting capacitor component, parallel connected with the fluo bulb,
wherein,
the starting capacitor is parallel connected with the fluo bulb at its supplying side;
on the fluorescent luminaire set two short connecting element, respectively short connecting each filament outside the fluo bulb.

15. A fluorescent luminaire according to claim 14, wherein, the fluorescent luminaire also comprises a thermal resistor, parallel connected with the fluo bulb at its load side.

16. A fluorescent luminaire according to claim 14, wherein, with the starting capacitor is in series connected a thermal protecting instrument, which can cut off the whole circuit when the coating on filament is evaporated and can not emit electron any more.

17. A method to start the fluorescent luminaire, consisting of
Set a high position trigger circuitry in ballast, to make the voltage of the two triodes superposed as the peak voltage of oscillation output on the pair of filaments;
Parallel connect the capacitor of the resonant circuitry in ballast with the pair of filaments at their load side, to pre-heat and start the fluo bulb with cold cathode form;
Short connect each filament outside the fluo bulb, so that when any filament is broken it will activate the fluo bulb with high voltage by using the peak voltage superposed on the bulb.

18. A method according to claim 17, wherein comprising: parallel connect a thermal resistor with the fluo bulb at its load side, so as to pre-heat and start the fluo bulb.

19. A method according to claim 17, wherein comprising: in the resonant circuitry is a thermal protecting instrument connected, by which when the coating on filament is evaporated and can not emit electron any more, the whole circuit is cut off due to the capacitor becomes the load of the oscillation output and the temperature of the thermal protecting instrument is raised by the increased current passing by.
